(19) United States
(12) Patent Application Publication
(10) Pub. No.: US 2004/0267473 A1
(43) Pub. Date: Dec. 30, 2004

(54) Method for transferring and utilizing data among laundry devices, users, and the like

(75) Inventors: William Michael Scheper, Guilford, IN (US); Richard Timothy Hartshorn, Lawrenceburg, IN (US); Christiaan Arthur Jacques Kamiel Thoen, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/876,109

(22) Filed: Jun. 24, 2004

Related U.S. Application Data
(60) Provisional application No. 60/482,959, filed on Jun. 27, 2003.

(51) Int. Cl. G01F 1/12

(52) U.S. Cl. 702/100

(57) ABSTRACT

Disclosed is a method for instructing users on performing an automatic home laundry process in a non-aqueous laundering apparatus comprising loading fabric articles into the non-aqueous laundering device, entering data describing the fabric articles, processing the data to determine the laundering process, and treating the fabric articles by the laundering process

### CROSS REFERENCE TO RELATED APPLICATIONS

This application claims the benefit of U.S. Provisional Application Ser. No. 60/482,959, filed on Jun. 27, 2003.

### FIELD OF INVENTION

The present invention relates to a method for transferring data among devices, users and service nodes for non-aqueous laundering.

### BACKGROUND

For centuries, fabric articles have been washed using water-based processes. In the last century, this chore was greatly simplified by the development of the automatic washing machine. However, while greatly simplifying the laundry process, even the home laundry process using the automatic washing machine still requires a significant amount of presorting fabric articles by color and textiles. Typically whites are washed separately from colored fabrics, and brightly colored fabric articles (e.g., dark reds and blues) from less highly colored articles. Often the instructions for the automatic washing machine are found on the bottom of the lid of the machine or on the detergent packaging. These instructions contain information detailing the correct settings for washing fabric articles. Often for the sake of simplicity, this information is captured in the form of a chart or table that can easily be read in order to select the proper cleaning settings.

More recently, water conservation efforts and environmental concerns have driven laundry machine manufacturers and laundry detergent manufacturers to reduce the amount of water required in the home laundry process. However, such efforts have focused on reducing water consumption by the wash medium rather than changing the wash medium from a primarily water based process.

A non-aqueous solvent based washing system utilizing lipophilic fluid, such as cyclic siloxanes (especially cyclopentasiloxanes, sometimes termed “D5”), particularly for use with washing machines for in-home use, has recently been developed. Such a system is particularly desired for cleaning textile articles without causing damage associated with wet-washing, like shrinkage and dye transfer. To maximize fabric cleaning in such a system it is necessary to use additives for cleaning, softening, finishing, etc. The use of such systems in the home poses issues through the use of necessary solvents and detergents where contact with user may occur. Therefore, it is desirable to have such system designed to minimize or eliminate user exposure to solvents and detergents, for example, a closed system or by a locked system that cannot be opened during an operating cycle of the system would be highly desirable.

A problem resulting from such systems being closed is that additives cannot be added to the washing cycle through traditional or known means, such as opening the door of the washing area and adding the additives. Therefore, there exists a desire for a method for addition of additives to a non-aqueous solvent based washing system utilizing lipophilic fluid that is a closed or locked system during the operating cycle.

Further, as non-aqueous solvent based washing systems involve increasingly complex technologies, their proper operation becomes increasingly difficult. Hence, regular maintenance and servicing becomes increasingly important, especially regarding the solvent and other consumables. Because the non-aqueous solvent based washing systems typically is not user serviceable, the amount of various solvents, detergents, and the like consumables will require a service technician to maintain. Therefore, it is desirable to have a non-aqueous based laundry apparatus that is a closed or locked system and is capable of performing automated laundering function as well automated maintenance/replenishment function.

Accordingly, there is an unmet need, in newer laundry technologies, particularly non-aqueous based laundry technologies for instructing the user of such technologies to the proper operation of such device. Further, there is an unmet need for the user of such technologies to receive training on the correct implementation of such a device. Also, there is an unmet need for the devices incorporating newer laundry technologies to communicate with a centralized node to communicate its operational status, including need for routine maintenance, supplies, or repair.

### SUMMARY

The present invention discloses a method of instructing a single user or a plurality of users on performing an automatic home laundry process in a non-aqueous laundering device comprising: loading fabric articles into the non-aqueous laundering device, entering data describing the fabric articles, processing the data to determine the laundering process, and treating the fabric articles by the laundering process.

The present invention also discloses a method of performing the home laundry process by a non-aqueous laundering device automatically.

The present invention also discloses a method of servicing and/or re-supplying a non-aqueous laundering device involving a node.

### BRIEF DESCRIPTION OF THE DRAWINGS

While the specification concludes with claims which particularly point out and distinctly claim the invention, it is believed certain aspects of the present invention will be better understood from the following description of preferred embodiments taken in conjunction with the accompanying drawings, in which like numerals indicate the same elements throughout the views and wherein numerals having the same last two digits (e.g., 20 and 120) connote similar or corresponding elements; and in which:

FIG. 1 is perspective view of a non-aqueous laundering device.

FIG. 2 is a sectional view of a non-aqueous laundering device.

### DETAILED DESCRIPTION

While the specification concludes with claims that particularly point out and distinctly claim the invention, it is believed the present invention will be better understood from the following description.

All ratios are weight ratios unless specifically stated otherwise.

Except as otherwise noted, all amounts including quantities, percentages, portions, and proportions, are understood to be modified by the word “about”, and amounts are not intended to indicate significant digits.

Except as otherwise noted, the articles “a”, “an”, and “the” mean “one or more”

Herein, “and/or” means subject X or subject Y or both.

Herein, “automatic home laundry process” means the laundry process as practiced by the consumer using an automatic washing machine, typically located within the consumer's residence (herein referred to as the process being conducted “in the home”), but also including public laundromats whereby the consumer follows essentially the same laundry process as though the automatic washing machine were present in the home.

Herein, “comprising” means that other steps and other ingredients, which do not affect the end result, can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein.

Herein, “domestic user” means an individual using a non-aqueous laundering apparatus for purposes of laundering personal and/or family member and/or friends' fabric article(s).

Herein, “professional user” means an individual or entity 1) using a non-aqueous laundering apparatus for purposes of laundering fabric article(s) as a paid-for service to another party, and/or 2) providing another party access (typically for a fee, as in the case of a laundromat) to a laundering apparatus for purposes of the other party laundering fabric article(s) in the apparatus.

Herein, “fabric article” means any article that is customarily cleaned in a conventional laundry process or in a dry cleaning process. As such the term encompasses articles of clothing, linen and drapery, clothing accessories, and floor coverings. The term also encompasses other items made in whole or in part of fabric, such as tote bags, furniture covers, tarpaulins and the like.

Herein, “fabric treating or treatment composition” or “fabric care composition” means any lipophilic fluid-containing composition that comes into direct contact with fabric articles to be treated. It should be understood that the term encompasses uses other than cleaning, such as refreshing, softening, conditioning and sizing. Thus, “fabric treating” and “fabric care” are used interchangeably herein. Optional cleaning adjuncts (such as additional detersive surfactants, bleaches, perfumes, and the like) and other fabric care agents may be added to the composition.

Herein, “dry clean only fabric articles” means those fabric articles readily identified by the fabric industry and consumers as unsafe for laundering by a conventional aqueous automatic home laundry process, and instead requiring special handling with a conventional non-aqueous solvent such as Perc. Again, consumers are frequently helped in this identification of fabric articles by manufacturer's tags identifying the fabric article as “dry clean only” or some similar description.

Herein, “machine washable fabric articles” means those fabric articles readily identified by the fabric industry and consumers as safe for laundering by a conventional aqueous automatic home laundry process. Consumers are frequently helped in this identification of fabric articles by manufacturer's tags identifying the fabric article as “machine washable” or some similar description.

Herein, “wash medium” means the liquid including but not limited to, fluid(s) and/or solution(s) and/or solvent(s) and/or emulsion(s)], which is used to wet the fabric articles in the wash load during the automatic home laundry process.

Herein, “non-aqueous laundering” refers to a process of treating and/or cleaning fabric articles comprising contacting the fabric articles with a cleaning fluid comprising a lipophilic fluid and removing from the fabric articles a portion of the cleaning fluid.

An embodiment of the present invention relates to a method for providing non-aqueous laundering capability comprising one or more of the, following steps: a) providing a non-aqueous laundering apparatus, b) installing the non-aqueous laundering apparatus, and servicing the non-aqueous laundering apparatus.

### A. NON-AQUEOUS LAUNDERING APPARATUS

While an apparatus having the various components as defined for the immersive commercial dry cleaning process as described in U.S. Pat. No. 6,059,845, issued May 9, 2000, and U.S. Pat. No. 6,063,135, issued May 16, 2000, if modified for residential size and consumer maintenance, could be used to practice the present invention process, an immersive process for the present process is not preferred. Reasons include the constraints (versus the commercial dry cleaner size and operation taught in these patents) associated with supplying, storing and cleaning larger volumes of lipophilic fluids at the laundering site; particularly where the laundering site is in the home.

For these reasons, apparatus for providing lower volume cleaning processes such as those utilizing a uniform spray process that completely wets the fabric articles with the lower volumes of wash medium as described herein before are contemplated with the methods of the present invention. For example, modifications of conventional low water wash appliances to deliver low levels of lipophilic fluid containing wash medium rather than a water wash medium should be considered; such conventional water wash appliances are described for example in U.S. Pat. Nos.: 4,489,574; 4,489,455; 5,191,669; 5,191,668; 5,233,718; and 5,671,494. Another example of an automatic washing machine useful for such low volume, aqueous as well as non-aqueous, cleaning is described in detail in U.S. Pat. No. 6,691,536. Another example is a laundering apparatus that delivers homogeneous coverage of the fabric articles with the lipophilic fluid containing wash medium by intermittent spin and spray followed by random tumbling until all the wash medium has been sprayed. Another example is an apparatus which reuses the lipophilic fluid-containing wash medium via an immediate re-use/recycling action, for example, by passing the wash medium over a particle removal filter after extraction from the fabric articles and then immediately spraying it back onto the fabric articles. Another example is a laundering apparatus designed to also dry the fabric articles in the same apparatus. This not only allows the user the convenience of not having to handle the wet fabric articles but also permits recovery of all the lipophilic fluid for reuse or cleaning.

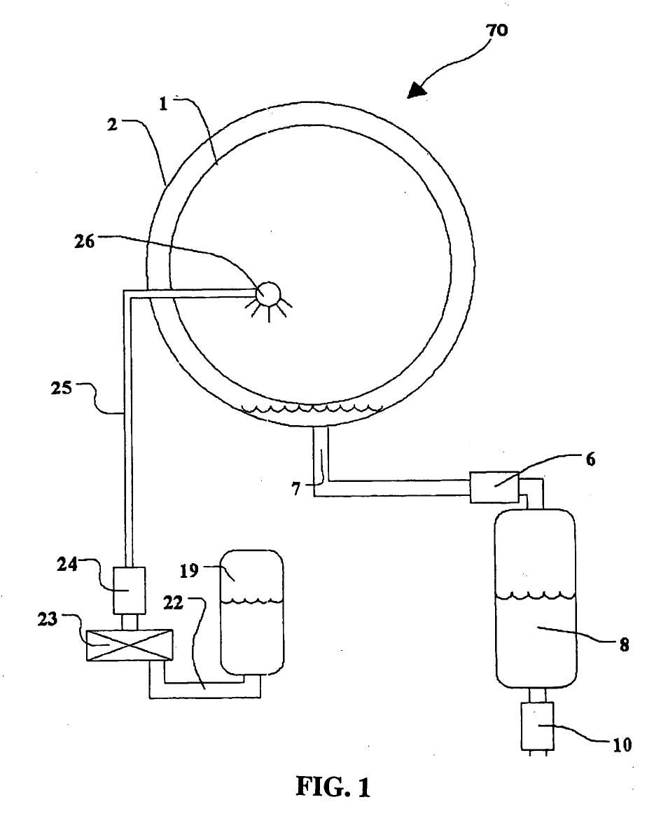

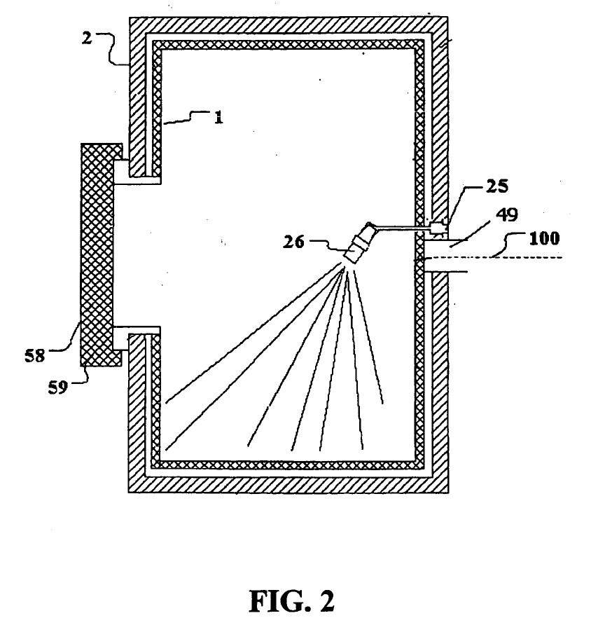

In one embodiment, the non-aqueous laundering apparatus 70 shown in FIG. 1, comprises a fabric-containing chamber 1 capable of receiving a fabric article to be treated and a non-aqueous laundering material (not shown and discussed herein below), wherein when a fabric article to be treated is present in the fabric-containing chamber 1, and a non-aqueous laundering material may be introduced into the fabric-containing chamber 1. The non-aqueous laundering apparatus 70, may further comprises an outer chamber 2 capable of receiving the non-aqueous laundering material from the fabric-containing chamber 1 that is not retained in said fabric-containing chamber 1. The outer chamber 2 typically houses the fabric-containing chamber 1. The fabric-containing chamber 1 and the outer chamber 2 typically are of cylindrical construction and have a horizontal access opening 58 and 59, respectively, and, as shown in FIG. 2. The horizontal center line of the outer chamber 2, which is typically stationary with respect to the fabric-containing chamber 1 coincides with the axis of rotation 100 of the movable fabric-containing chamber 1 movably mounted within the outer chamber 2. The outer chamber 2 typically comprises an exit port or drain 7 through which the non-aqueous laundering material received by the outer chamber 2 exits the outer chamber 2. The fabric-containing chamber 1 is typically rotatably secured to outer chamber 2 by means of drive shaft 49 (FIG. 2). The cross-sectional views of FIG. 2, the outer chamber 2 may have a door 59 having a circular shape with an outer edge, the door 59 is capable of opening and closing and may be used to load and unload fabric articles from the non-aqueous laundering apparatus 70. The fabric-containing chamber 1 may have an access opening 58 used to load and unload fabric articles from the non-aqueous laundering apparatus 70; typically which is concentrically aligned with the outer edge of the door 59 in outer chamber 2. When the non-aqueous laundering apparatus 70 is in operation, the door 59 is in the closed position, typically locked by a locking means (not shown) when the non-aqueous laundering apparatus 70 is in operation.

At least one large storage tank 19 may contain the non-aqueous laundering material that is delivered to the fabric-containing chamber 1 via an applicator 26, typically a spray nozzle. The desired non-aqueous laundering materials are delivered into the applicator 26 typically by pumping with pump 24. The non-aqueous laundering material stored in the large storage tank 19 is pumped from through lines 22, first passing through valve 23, then through pump 24, then finally through line 25 to applicator 26.

Once the non-aqueous laundering material enters the fabric article chamber 1, it is collected in the outer chamber 2. The non-aqueous laundering material exits the outer chamber 2 by use of a drain 7 and then enters a recover tank 8. Prior to delivering home dry cleaning materials into recovery tank 8, home dry cleaning materials are filtered in filter 6. Typically an air compressor (not shown) would be connected to the large storage tank 19 by pressure lines. Other means of conveying home dry cleaning materials may include gravity, centrifugal, diaphragm, piston, or peristaltic pumps.

Filter 6 removes solid waste such as lint, fabric fibers and large particulate soil, so they don't settle on the recovery tank 8 bottom and clog downstream lines. Also, filter 6 assures reliable operation of pump 10, since pump 10 is a typically higher pressure pump, which generally is of a type more easily damaged by solids. Typically, an automatic means (not shown) may be associated with the filter 6 such that any solid wastes may be disposed of without the user interacting with the solid waste. The automatic means may be a mechanism that removes solid wastes from the filter 6 and transports them to be disposed of down the drain. Alternatively, the automatic means may be a mechanism that removes solid wastes from the filter and transports the solid waste to another waste container (not shown), which can then be removed by the user from the non-aqueous laundering apparatus 70.

The automatic means (not shown) may be a system wherein gas or fluid is backflushed through the filter to remove any solid wastes. As used herein “backflushed” means that gas or fluid is forced through the filter in the direction opposite that fluid generally passes from the drain 7 to the recovery tank 8.

The waste container (not shown) may comprise material that is inexpensive, relatively non-aqueous laundering material repellant, and easily disposable such as plastic bags, plastic containers, coated paper bags, coated paper containers, and any combinations thereof. As used in “relatively non-aqueous laundering repellant” means that a non-aqueous laundering material does not easily penetrate through the container material even upon standing for several hours or days. Typically, the container material is environmentally friendly and has biodegradable properties.

The non-aqueous laundering material can comprise various components, such as lipophilic fluids, surfactants, processing aids, additives, polar solvents, and cleaning adjuncts. Because of the chemical nature of many of these components, in one embodiment, the non-aqueous laundering apparatus locks and/or seals itself when in operation in order to minimize or eliminate exposing users to these components.

In a separate embodiment, the non-aqueous laundering apparatus can be a “bimodal laundry machine”. Herein, “bimodal laundry machine” refers to a single piece of equipment that has the ability to function either as a traditional aqueous automatic washing machine, having an aqueous laundry cycle, or as a non-aqueous laundering apparatus based on either a user or a professional user input or based on data from a node or data from fabric articles. A nonlimiting example of such a machine is disclosed in U.S. Pat. No. 2003/0,046,963 A1. Such equipment would allow a user to choose whether to run a non-aqueous laundering cycle or a traditional water wash cycle.

### B. INSTALLING A NON-AQUEOUS LAUNDERING APPARATUS

Another aspect of the present invention includes the step of installing a non-aqueous laundering apparatus. The non-aqueous laundering apparatus may be installed in a commercial location (e.g., a commercial dry-cleaner, self-serve laundromat, common area in an apartment building, etc.) or in a domestic location (e.g., in a domestic user's house, apartment, mobile home, etc.). Installation may involve merely delivering and unpackaging of the non-aqueous laundering apparatus, for non-aqueous laundering apparatuses that do not require an external source of lipophilic fluid and/or adjunct fluid (e.g., the lipophilic fluid is self-contained in the non-aqueous laundering apparatus, and adjunct fluids are also self-contained and/or may be added directly to the non-aqueous laundering apparatus by the user). Alternatively, installation may further include connecting the non-aqueous laundering apparatus to a lipophilic fluid source, impinging gas source, adjunct fluids source, plumbing, drainage to outside the installation site, and ventilation to outside the installation site. If a bimodal laundering apparatus is used, connection to a water source is also part of the installation step. In most cases, the laundering apparatus would be readily connected to a power source during installation, or by the user subsequent to installation.

In one embodiment, the non-aqueous laundering apparatus is delivered to the installation site without one or more of the following contained in the non-aqueous laundering apparatus: lipophilic fluid, impinging gas, and/or adjunct fluid. In such an embodiment, the installing step may further include addition of such fluid(s) and/or gas to the non-aqueous laundering apparatus at the installing site.

Installation may further include testing of the non-aqueous laundering apparatus by the installing party, to confirm that the non-aqueous laundering apparatus is in proper working order.

In another embodiment, installation may include providing the user with training materials (e.g., hard copy, video, or computer file instructions) on how to use the non-aqueous laundering apparatus. Alternatively, such training may be provided the installer physically demonstrating to the user, how to operate the non-aqueous laundering apparatus.

In one embodiment of a “bimodal” laundry apparatus, the aqueous laundering cycle could be used for a traditional aqueous automatic home laundry process and the non-aqueous laundry process would be used for fabric articles having a care label that instructs the consumer to dryclean the fabric article. In this embodiment the user would have the flexibility to select the best cycle for the given cleaning task and launder all fabric articles in view of the care labels.

For a non-aqueous automatic washing machine, whether the machine has the added capability to also run a traditional aqueous laundry cycle or only has the non-aqueous laundering cycle, the user will need to be trained how to operate the non-aqueous automatic washing machine to achieve optimal performance. This training comprises instruction on how to operate the non-aqueous automatic washing machine and also how to choose dry clean only fabric articles and/or machine washable fabric articles appropriate for non-aqueous/aqueous laundering. This may include, but is not limited to, instruction by the sales personnel at the point of purchase, training during installation, on-line web site training material, video training, instructions on the machine including an interactive touch panel display to guide the user through the process.

### C. GATHERING PROCESS DATA

The non-aqueous laundering apparatus of the present invention is capable of receiving, storing, and transmitting data pertaining to the operation of the device and the laundering of fabric articles. The non-aqueous laundering apparatus is able to gather data by receiving data from a user, receiving data from fabric articles, receiving data from a node, and receiving data from combinations thereof. In a preferred method, data is received from a user.

In one embodiment, data is inputted by the user. Such data may include any parameters for the laundering of fabric articles including, but not limited to fabric type, type of stains, level of soiling, level of odor, color composition, color fastness, load size, and the like. Any method of inputting data into the non-aqueous laundering apparatus can be utilized, for example, data inputting may be accomplished by a user through a user interface.

In another embodiment, data is received from the fabric articles themselves. In one embodiment, the non-aqueous laundering apparatus determines the type of fabric article being laundered by scanning an identification tag attached to the fabric article. Such garment identification tags are disclosed in WO 02/27608 A1. In another embodiment, the non-aqueous laundering apparatus determines the necessary process data by scanning the emanations from the fabric articles. Specifically, malodors and stain compositions are examined by the non-aqueous laundering apparatus to extract data pertaining to the operation of the device and the laundering of the fabric articles. In another embodiment, the non-aqueous laundering apparatus is equipped with multiple sensors, each sensor is capable of determining a parameter for the laundering process. Examples of such sensors useful in the automated laundering apparatus include, but are not limited to, a load sensor, an odor sensor, a color sensor, a soil sensor, a garment tag sensor, and the like.

In yet another embodiment, data is received from the user and/or the laundering device and transmitted to a node capable of receiving and sending information to one or more non-aqueous laundering apparatuses or users. Such a node is capable of processing any information sent to it by a user or non-aqueous laundering apparatus. Information useful for the present invention include, but are not limited to, information about the fabric articles, such as the fabric type, load, color; information about the laundering apparatus, such as the level of cleaning solvents, the level of the compositions or additives, the status of the filters, the status of the connecting lines, pumps, valves within the apparatus. The information is processed and/or analyzed by the node against certain pre-determined parameters or certain individualized criteria, and the node sends response data to the apparatus, the user or a service provider, such that the recipients of the response data can take action accordingly, for example, starting a specific treating process or implementing services to the laundering apparatus.

The node typically is a centralized response center. In one embodiment, the node comprises a machine having data processing capability, such as a computer with one or more data processors. In another embodiment, the node comprises humans located in a call center or just a user with access to the apparatus. In yet another embodiment, the node is a combination of human and machine working collaboratively to receive information, process the information received, and sending response data.

### D. USER INTERFACE

The user interface of the non-aqueous laundering apparatus comprises a means capable of communicating process data to a user and capable of processing the data entered by the user for use by the non-aqueous laundering apparatus. Preferred consumer interface means comprise buttons, dials, touch screens, remote controls, computer screen/mouse/keyboard, and any combination thereof. Furthermore, it is well within the scope of the present invention for multiple selectors to be present. For example, using one selector the consumer/operator could input load size, and using another input the types of fabric to be treated. Alternatively, all these functions could be done on one selector. Any such selector would have at least two selector positions. Possible combinations of selector positions include:

1. at least one selected from “dry-clean”, “delicate care label” and “light soil” and at least one selected from “water wash”, “normal”, and “high soil”;

2. at least one selected from “dry-clean”, “delicate care label” and “light soil” and at least one selected from “refresh”, “deodorize”, “fabric treatment” and “rinse/soften”;

3. at least one selected from “dry-clean”, “delicate care label”, “light soil”, and “high soil”; and at least one selected from “bleach and detergent”, “bleach only”, and “detergent only”;

In one preferred embodiment any programmable selector would have at least three selector positions including at least one selected from “dry-clean”, “delicate care label” and “light soil”, at least one selected from “water wash”, “normal”, and “high soil”, and at least one selected from “refresh”, “deodorize”, “fabric treatment” and “rinse/soften”.

Once the user selects the desired cleaning options, the input from the user is transmitted from the user interface to the non-aqueous laundering apparatus where the input is processed and appropriate actions are carried out by the non-aqueous laundering apparatus.

The user interface of the non-aqueous laundering apparatus optionally can display device information for the user. Such information can include the status of the non-aqueous laundering apparatus, including maintenance schedules, non-aqueous laundering material levels, status of node, present stage of the fabric treatment cycle, remaining time for fabric treatment cycle, information sent from the node, and the like.

### E. DATA DELIVERY

Any method of delivering information from the node to the non-aqueous laundering apparatus can be used. Suitable delivery methods include using an internet, using an intranet, using a networking system, a telephone—including voice lines and data lines, cellular technology, satellite technology, cable technology, radio waves, optical transmissions, and combinations thereof.

### F. DATA PROCESSING

Upon gathering data from the user, the fabric articles, and/or the node, the data can be processed into a set of instructions for the non-aqueous laundering apparatus. In one embodiment, the data is processed into a set of instructions for the treatment of the fabric articles. These treatment instructions can include instructions pertaining to laundering processes, such as pre-treatment and post-treatment, additive addition (e.g., type of additives, quantity of the additives, the sequence or cycle to add the additives), fabric treatment processes, drying processes, and the like. In another embodiment, the data delivered include instructions such that the apparatus merely execute the instructions in a laundering process.

### G. LAUNDERING PROCESSES

The laundering processes of the present invention typically include treating the fabric articles with a lipophilic fluid within the non-aqueous laundering device. One preferred method for applying the lipophilic fluid involves multiple spin, spray and tumble cycles. Optionally, additives are added and/or mixed with the lipophilic fluid in the non-aqueous laundering apparatus.

“Lipophilic fluid” or “lipophilic cleaning fluid” as used herein means any liquid or mixture of liquid that is immiscible with water at up to 20% by weight of water. In general, a suitable lipophilic fluid can be fully liquid at ambient temperature and pressure, can be an easily melted solid, e.g., one that becomes liquid at temperatures in the range from about 0° C. to about 60° C., or can comprise a mixture of liquid and vapor phases at ambient temperatures and pressures, e.g., at 25° C. and 1 atm pressure.

It is preferred that the lipophilic fluid herein be non-flammable or, have relatively high flash points and/or low VOC characteristics, these terms having conventional meanings as used in the dry cleaning industry, to equal or, preferably, exceed the characteristics of known conventional dry cleaning fluids.

Non-limiting examples of suitable lipophilic fluid materials include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

“Siloxane” as used herein means silicone fluids that are non-polar and insoluble in water or lower alcohols. Linear siloxanes (see for example U.S. Pat. Nos. 5,443,747, and 5,977,040) and cyclic siloxanes are useful herein, including the cyclic siloxanes selected from the group consisting of octamethyl-cyclotetrasiloxane (tetramer), dodecamethyl-cyclohexasiloxane (hexamer), and preferably decamethyl-cyclopentasiloxane (pentamer, commonly referred to as “D5”). A preferred siloxane comprises more than about 50% cyclic siloxane pentamer, more preferably more than about 75% cyclic siloxane pentamer, most preferably at least about 90% of the cyclic siloxane pentamer. Also preferred for use herein are siloxanes that are a mixture of cyclic siloxanes having at least about 90% (preferably at least about 95%) pentamer and less than about 10% (preferably less than about 5%) tetramer and/or hexamer.

The lipophilic fluid can include any fraction of dry-cleaning solvents, especially newer types including fluorinated solvents, or perfluorinated amines. Some perfluorinated amines such as perfluorotributylamines, while unsuitable for use as lipophilic fluid, may be present as one of many possible adjuncts present in the lipophilic fluid-containing composition.

Other suitable lipophilic fluids include, but are not limited to, diol solvent systems e.g., higher diols such as C6 or C8 or higher diols, organosilicone solvents including both cyclic and acyclic types, and the like, and mixtures thereof.

Non-limiting examples of low volatility non-fluorinated organic solvents include for example OLEAN® and other polyol esters, or certain relatively nonvolatile biodegradable mid-chain branched petroleum fractions.

Non-limiting examples of glycol ethers include propylene glycol methyl ether, propylene glycol n-propyl ether, propylene glycol t-butyl ether, propylene glycol n-butyl ether, dipropylene glycol methyl ether, dipropylene glycol n-propyl ether, dipropylene glycol t-butyl ether, dipropylene glycol n-butyl ether, tripropylene glycol methyl ether, tripropylene glycol n-propyl ether, tripropylene glycol t-butyl ether, tripropylene glycol n-butyl ether.

Non-limiting examples of other silicone solvents, in addition to the siloxanes, are well known in the literature, see, for example, Kirk Othmer's Encyclopedia of Chemical Technology, and are available from a number of commercial sources, including GE Silicones, Toshiba Silicone, Bayer, and Dow Corning. For example, one suitable silicone solvent is SF-1528 available from GE Silicones.

Non-limiting examples of glycerine derivative solvents include materials having the following structure:

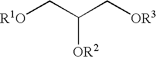

wherein R1, R2 and R3 are each independently selected from: H; branched or linear, substituted or unsubstituted C1-C30 alkyl, C2-C30 alkenyl, C1-C30 alkoxycarbonyl, C3-C30 alkyleneoxyalkyl, C1-C30 acyloxy, C7-C30 alkylenearyl; C4-C30 cycloalkyl; C6-C30 aryl; and mixtures thereof. Two or more of R1, R2 and R3 together can form a C3-C8 aromatic or non-aromatic, heterocyclic or non-heterocyclic ring.

Non-limiting examples of suitable glycerine derivative solvents include 2,3-bis(1,1-dimethylethoxy)-1-propanol; 2,3-dimethoxy-1-propanol; 3-methoxy-2-cyclopentoxy-1-propanol; 3-methoxy-1-cyclopentoxy-2-propanol; carbonic acid (2-hydroxy-1-methoxymethyl)ethyl ester methyl ester; glycerol carbonate and mixtures thereof.

Non-limiting examples of other environmentally-friendly solvents include lipophilic fluids that have an ozone formation potential of from about 0 to about 0.31, lipophilic fluids that have a vapor pressure of from about 0 to about 0.1 mm Hg, and/or lipophilic fluids that nave a vapor pressure of greater than 0.1 mm Hg, but have an ozone formation potential of from about 0 to about 0.31. Non-limiting examples of such lipophilic fluids that have not previously been described above include carbonate solvents (i.e., methyl carbonates, ethyl carbonates, ethylene carbonates, propylene carbonates, glycerine carbonates) and/or succinate solvents (i.e., dimethyl succinates).

“Ozone Reactivity” as used herein is a measure of a VOC's ability to form ozone in the atmosphere. It is measured as grams of ozone formed per gram of volatile organics. A methodology to determine ozone reactivity is discussed further in W. P. L. Carter, “Development of Ozone Reactivity Scales of Volatile Organic Compounds”, Journal of the Air & Waste Management Association, Vol. 44, Page 881-899, 1994. “Vapor Pressure” as used can be measured by techniques defined in Method 310 of the California Air Resources Board.

Preferably, the lipophilic fluid comprises more than 50% by weight of the lipophilic fluid of cyclopentasiloxanes, (“D5”) and/or linear analogs having approximately similar volatility, and optionally complemented by other silicone solvents.

The lipophilic cleaning fluid may optionally be a combination of lipophilic fluid and an adjunct ingredient. The lipophilic cleaning and adjunct ingredient may be a mixture, which is distributed over the fabric articles at the same time, or they may be added by separate sources and distributed over the fabric articles at the same time. Alternatively, the lipophilic fluid and the adjunct ingredient may be added separately in any possible combination, such as, lipophilic fluid then adjunct ingredient or adjunct ingredient then lipophilic fluid, etc. The lipophilic fluid and the adjunct ingredient may be stored separately and mixed prior to application, or stored as a mixture, that is stored together as the lipophilic cleaning fluid. The adjunct ingredient is added to the lipophilic fluid to improve soil removal and/or impart desired properties/finish to the treated fabric articles. Combinations or mixtures of adjunct ingredient are also envisioned.

One embodiment of the present invention is a method for treating fabric articles in an apparatus of the present invention. In one embodiment of this aspect of the present invention the method comprises treating one or more of said fabric articles within an non-aqueous laundering apparatus capable of

(i) evenly distributing a lipophilic cleaning fluid on a retained load of fabric articles and

(ii) removing said lipophilic cleaning fluid from said articles.

Another embodiment of the present invention method for treating fabric articles in an apparatus of the present invention. In one embodiment of this aspect of the present invention the method comprises

(I) one or more steps of prespotting, soaking or pretreating a fabric article or a load of fabric articles by any conventional process; and

(II) at least one step of treating said fabric article or load of fabric articles in an appliance according to any of the foregoing appliance claims.

By “one or more steps of prespotting, soaking or pretreating a fabric article or a load of fabric articles by any conventional process” it is meant that the fabric article or load is pretreated, prespotted or soaked exactly as if they were to be treated before being cleaned or treated either a conventional domestic or commercial aqueous laundry apparatus, or commercial dry cleaning apparatus. For example, the fabric article or load is let soak overnight immersed in an aqueous bath containing a bleach solution and then treated in the apparatus of the present invention; or a preatreater solution is applied to stain on a fabric article which is then treated in the apparatus of the present invention, etc.

In another embodiment of this aspect of the present invention the method comprises

(I) at least one step of treating a fabric article or load of fabric articles in an appliance according to any of the foregoing appliance claims and

(II) one or more steps of post-treating said fabric article or a load of fabric articles by any conventional process.

By “one or more steps of post-treating the fabric article or a load of fabric articles by any conventional process” it is meant that the fabric article or load is post-treated exactly as if they were to be post-treated after being cleaned or treated in a conventional domestic or commercial water laundry apparatus, or commercial dry cleaning apparatus. For example, the fabric article is contacted with a fabric softener after being treated in the apparatus of the present invention, etc.

### ADDITIVES

The non-aqueous laundering materials can have many different components. Any component that can be utilized to effectively treat a fabric article can be used. The following compenents represent non-limiting examples of effective additives.

### NONIONIC SURFACTANTS

The surfactant suitable for use in the present invention has the general formula:

Yᵤ-(Lₜ-Xᵥ)ₓ-Y′_{w} (I)

L_{y}-(Xᵥ-Yᵤ)ₓ-L′₂ (II)

and mixtures thereof.

wherein L and L′ are solvent compatibilizing (or lipophilic) moieties, which are independently selected from:

(a) C1-C22 alkyl or C4-C12 alkoxy, linear or branched, cyclic or acyclic, saturated or unsaturated, substituted or unsubstituted;

(b) siloxanes having the formula:

MₐD_{b}D′_{c}D″_{d}

wherein a is 0-2; b is 0-1000; c is 0-50; d is 0-50, provided that a+c+d is at least 1;

M is R¹₃₋ₑXₑSiO_{1/2} wherein R¹ is independently H, or a alkyl group, X is hydroxyl group, and e is 0 or 1;

D is R⁴₂SiO2/2 wherein R⁴ is independently H or a alkyl group;

D′ is R⁵₂SiO_{2/2} wherein R⁵ is independently R² provided that at least one R⁵ is (CH₂)_{f}(C₆Q₄)_{g}O—(C₂H₄O)ₕ—(C₃H₆O)ᵢ(CₖH₂ₖ)ⱼ-R³, wherein R³ is independently H, a alkyl group or an alkoxy group, f is 1-10, g is 0 or 1, h is 1-50, i is 0-50, j is 0-50, k is 4-8; C₆Q₄ is unsubstituted or substituted; Q is independently selected from H, C₁₋₁₀ alkyl, C₂₋₁₀ alkenyl, and mixtures thereof; and

D″ is R⁶₂SiO_{2/2} wherein R⁶ is independently H, a alkyl group or (CH₂)_{I}(C₆Q₄)ₘ(A)ₙ-[(T)ₒ-(A′)ₚ-]_{q}-(T′)ᵣZ(G)ₛ, wherein 1 is 1-10; m is 0 or 1; n is 0-5; o is 0-3; p is 0 or 1; q is 0-10; r is 0-3; s is 0-3; C₆Q₄ is unsubstituted or substituted; Q is independently selected from H, C₁₋₁₀ alkyl, C₂₋₁₀ alkenyl, and mixtures thereof; A and A′ are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof; T and T′ are each independently a C₁₋₃₀ straight chained or branched alkyl or alkenyl or an aryl which is unsubstituted or substituted; Z is a hydrogen, carboxylic acid, a hydroxy, a phosphato, a phosphate ester, a sulfonyl, a sulfonate, a sulfate, a branched or straight-chained polyalkylene oxide, a nitryl, a glyceryl, an aryl unsubstituted or substituted with a C₁₋₃₀ alkyl or C₂₋₁₀ alkenyl, a carbohydrate unsubstituted or substituted with a C₁₋₁₀ alkyl or C₂₋₁₀ alkenyl, or an ammonium; G is an anion or cation such as H⁺, Na⁺, Li⁺, K⁺, NH₄⁺, Ca⁺², Mg⁺², Cl⁻, Br⁻, I⁻, mesylate or tosylate; and D″ can be capped with C1-C4 alkyl or hydroxy groups;

Y and Y′ are hydrophilic moieties, which are independently selected from hydroxy; polyhydroxy; C1-C3 alkoxy; mono- or di- alkanolamine; C1-C4 alkyl substituted alkanolamine; substituted heterocyclic containing O, S, N; sulfates; carboxylate; carbonate; and when H and/or H′ is ethoxy (EO) or propoxy (PO), it must be capped with R, which is selected from the group consisting of: a 4 to 8 membered, substituted or unsubstituted, heterocyclic ring containing from 1 to 3 hetero atoms; and

linear or branched, saturated or unsaturated, substituted or unsubstituted, cyclic or acyclic, aliphatic or aromatic hydrocarbon radicals having from about 1 to about 30 carbon atoms;

X is a bridging linkage selected from O; S; N; P; C1 to C22 alkyl, linear or branched, saturated or unsaturated, substituted or unsubstituted, cyclic or acyclic, aliphatic or aromatic, interrupted by O, S, N, P; glycidyl, ester, arido, amino, PO₄²⁻, HPO₄⁻, PO₃²⁻, HPO₃⁻, which are protonated or unprotonated;

u and w are integers independently selected from 0 to 20, provided that u+w≧1;

t is an integer from 1 to 10;

v is an integer from 0 to 10;

x is an integer from 1 to 20; and

y and z are integers independently selected from 1 to 10.

Nonlimiting examples of surfactants having the above formula include: alkanolamines; phophate/phosphonate esters; gemini surfactants including, but are not limited to, gemini diols, gemini amide alkoxylates, gemini amino alkoxylates; capped nonionic surfactants; (5) capped silicone surfactants such as nonionic silicone ethoxylates, silicone amine derivatives; alkyl alkoxylates; polyol surfactants; and mixtures thereof.

Another class of surfactant can include siloxane-based surfactants. The siloxane-based surfactants in this application may be siloxane polymers for other applications. The siloxane-based surfactants typically have a weight average molecular weight from 500 to 20,000 daltons. Such materials, derived from poly(dimethylsiloxane), are well known in the art. In the present invention, not all such siloxane-based surfactants are suitable, because they do not provide improved cleaning of soils compared to the level of cleaning provided by the lipophilic fluid itself.

Suitable siloxane-based surfactants comprise a polyether siloxane having the formula:

MₐD_{b}D′_{c}D″_{d}M′₂₋ₐ

wherein a is 0-2; b is 0-1000; c is 0-50; d is 0-50, provided that a+c+d is at least 1;

M is R¹₃₋ₑXₑSiO_{1/2} wherein R¹ is independently H, or a alkyl group, X is hydroxyl group, and e is 0 or 1;

M′ is R²₃SiO_{1/2} wherein R² is independently H, a alkyl group, or (CH₂)_{f}(C₆Q₄)_{g}O—(C₂H₄O)ₕ—(C₃H₆O)ᵢ(CₖH₂ₖ)ⱼ-R³, provided that at least one R² is (CH₂)_{f}(C₆Q₄)_{g}O—(C₂H₄Oₕ—(C₃H₆O)ᵢ(CₖH₂ₖ)ⱼ-R³, wherein R³ is independently H, a alkyl group or an alkoxy group, f is 1-10, g is 0 or 1, h is 1-50, i is 0-50, j is 0-50, k is 4-8; C₆Q₄ is unsubstituted or substituted; Q is independently selected from H, C, ₁₀ alkyl, C₂-₁₀ alkenyl, and mixtures thereof;

D is R⁴₂SiO_{2/2} wherein R⁴ is independently H or a alkyl group;

D′ is R⁵₂SiO_{2/2} wherein R⁵ is independently R² provided that at least one R⁵ is (CH₂)_{f}(C₆Q₄)_{g}O—(C₂H₄O)ₕ—(C₃H₆O)ᵢ(CₖH₂ₖ)ⱼ-R³, wherein R³ is independently H, a alkyl group or an alkoxy group, f is 1-10, g is 0 or 1, h is 1-50, i is 0-50, j is 0-50, k is 4-8; C₆Q₄ is unsubstituted or substituted; Q is independently selected from H, C₁₋₁₀ alkyl, C₂₋₁₀ alkenyl, and mixtures thereof; and

D″ is R⁶₂SiO₂, wherein R⁶ is independently H, a alkyl group or (CH₂)ₗ(C₆Q₄)ₘ(A)ₙ-[(T)ₒ-(A′)ₚ—]_{q}-(T′)ᵣZ(G)ₛ, wherein 1 is 1-10; m is 0 or 1; n is 0-5; o is 0-3; p is 0 or 1; q is 0-10; r is 0-3; s is 0-3; C₆Q₄ is unsubstituted or substituted; Q is independently selected from H, C₁₋₁₀ alkyl, C₂-₁₀ alkenyl, and mixtures thereof; A and A′ are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof; T and T′ are each independently a C₁₋₃₀ straight chained or branched alkyl or alkenyl or an aryl which is unsubstituted or substituted; Z is a hydrogen, carboxylic acid, a hydroxy, a phosphato, a phosphate ester, a sulfonyl, a sulfonate, a sulfate, a branched or straight-chained polyalkylene oxide, a nitryl, a glyceryl, an aryl unsubstituted or substituted with a C₁₋₃₀ alkyl C₂₋₁₀ alkenyl, a carbohydrate unsubstituted or substituted with a C₁₋₁₀ alkyl or C₂₋₁₀ alkenyl, or an ammonium; G is an anion or cation such as H⁺, Na⁺, Li⁺, K⁺, NH₄⁺, Ca⁺², Mg⁺², Cl⁻, Br⁻, I⁻, mesylate or tosylate.

Examples of the types of siloxane-based surfactants described herein above may be found in EP-1,043,443A1, EP-1,041,189 and WO-01/34,706 (all to GE Silicones) and U.S. Pat. No. 5,676,705, U.S. Pat. No. 5,683,977, U.S. Pat. No. 5,683,473, and EP-1,092,803A1 (all assigned to Lever Brothers).

Nonlimiting commercially available examples of suitable siloxane-based surfactants are TSF4446 (ex. General Electric Silicones), XS69-B5476 (ex. General Electric Silicones); Jenamine HSX (ex. DelCon) and Y12147 (ex. OSi Specialties).

Yet another preferred class of materials suitable for the surfactant component is organic in nature. Preferred materials are organosulfosuccinate surfactants, with carbon chains of from about 6 to about 20 carbon atoms. Most preferred are organosulfosuccinates containing dialkly chains, each with carbon chains of from about 6 to about 20 carbon atoms. Also preferred are chains containing aryl or alkyl aryl, substituted or unsubstituted, branched or linear, saturated or unsaturated groups. Nonlimiting commercially available examples of suitable organosulfosuccinate surfactants are available under the trade names of Aerosol OT and Aerosol TR-70 (ex. Cytec).

The surfactant component, when present in the compositions of the present invention, preferably comprises from about 1% to about 99%, more preferably 2% to about 75%, even more preferably from about 5% to about 60% by weight of the composition.

When the composition is diluted with a lipophilic fluid to prepare the wash liquor, the surfactant component preferably comprises from about 0.01% to about 10%, more preferably from about 0.02% to about 5%, even more preferably from about 0.05% to about 2% by weight of the wash liquor.

### POLAR SOLVENT

Compositions according to the present invention may further comprise a polar solvent. Non-limiting examples of polar solvents include: water, alcohols, glycols, polyglycols, ethers, carbonates, dibasic esters, ketones, other oxygenated solvents, and mixtures thereof. Further examples of alcohols include: C1-C126 alcohols, such as propanol, ethanol, isopropyl alcohol, and the like, benzyl alcohol, and diols such as 1,2-hexanediol. The DOWANOL® series by Dow Chemical are examples of glycols and polyglycols useful in the present invention, such as DOWANOL® TPM, TPnP, DPnB, DPnP, TPnB, PPh, DPM, DPMA, DB, and others. Further examples include propylene glycol, butylene glycol, polybutylene glycol and more hydrophobic glycols. Examples of carbonate solvents are ethylene, propylene and butylene carbonantes such as those available under the JEFFSOL® tradename. Polar solvents for the present invention can be further identified through their dispersive (δ_{D}), polar (δ_{P}) and hydrogen bonding (δ_{H}) Hansen solubility parameters. Preferred polar solvents or polar solvent mixtures have fractional polar (f_{P}) and fractional hydrogen bonding (f_{H}) values of fₚ>0.02 and f_{H>}0.10, where f_{P}=δ_{P}/(δ_{D}+δ_{P}+δ_{H}) and f_{H}=δ_{H}/(δ_{D}+δ_{P}+δ_{H}), more preferably f_{P}>0.05 and f_{H}>0.20, and most preferably f_{P}>0.07 and f_{H}>0.30.

In the detergent composition of the present invention, the levels of polar solvent can be from about 0 wt % to about 70 wt %, preferably about 1 wt % to about 50 wt % even more preferably about 1 wt % to about 30 wt % by weight of the detergent composition.

When the composition of the present invention comprises an amino-functional silicone as the only emulsifying agent, preferred levels of polar solvent are from about 0.01 wt % to about 2 wt %, preferably about 0.05 wt % to about 0.8 wt %, even more preferably about 0.1 wt % to about 0.5 wt % by weight of the detergent composition.

When the detergent composition of the present invention comprises higher levels of polar solvent, the detergents compositions preferably comprise from about 2 wt % to about 25 wt %, more preferably from about 5 wt % to about 20 wt %, even more preferably from about 8 wt % to about 15 wt % by weight of the detergent composition.

### CLEANING ADJUNCTS

The detergent compositions of the present invention optionally further comprise at least one additional cleaning adjunct. The cleaning adjuncts can vary widely and can be used at widely ranging levels. For example, detersive enzymes such as proteases, amylases, cellulases, lipases and the like as well as bleach catalysts including the macrocyclic types having manganese or similar transition metals all useful in laundry and cleaning products can be used herein at very low, or less commonly, higher levels. Cleaning adjuncts that are catalytic, for example enzymes, can be used in “forward” or “reverse” modes, a discovery independently useful from the fabric treating methods of the present invention. For example, a lipolase or other hydrolase may be used, optionally in the presence of alcohols as cleaning adjuncts, to convert fatty acids to esters, thereby increasing their solubility in the lipophilic fluid. This is a “reverse” operation, in contrast with the normal use of this hydrolase in water to convert a less water-soluble fatty ester to a more water-soluble material. In any event, any cleaning adjunct must be suitable for use in combination with a lipophilic fluid in accordance with the present invention.

Some suitable cleaning adjuncts include, but are not limited to, builders, surfactants, other than those described above with respect to the surfactant component, enzymes, bleach activators, bleach catalysts, bleach boosters, bleaches, alkalinity sources, antibacterial agents, colorants, perfumes, pro-perfumes, finishing aids, lime soap dispersants, odor control agents, odor neutralizers, polymeric dye transfer inhibiting agents, crystal growth inhibitors, photobleaches, heavy metal ion sequestrants, anti-tarnishing agents, anti-microbial agents, anti-oxidants, anti-redeposition agents, soil release polymers, electrolytes, pH modifiers, thickeners, abrasives, divalent or trivalent ions, metal ion salts, enzyme stabilizers, corrosion inhibitors, diamines or polyamines and/or their alkoxylates, suds stabilizing polymers, solvents, process aids, fabric softening agents, optical brighteners, hydrotropes, suds or foam suppressors, suds or foam boosters and mixtures thereof.

Optionally, the compositions useful for the present invention may comprise processing aids. Processing aids facilitate the formation of the cleaning compositions by maintaining the fluidity and/or homogeneity of the consumable detergent composition, and/or aiding in the dilution process. Processing aids suitable for the present invention are solvents, preferably solvents other than those described above, hydrotropes, and/or surfactants, preferably surfactants other than those described above with respect to the surfactant component. Particularly preferred processing aids are protic solvents such as aliphatic alcohols, diols, triols, etc. and nonionic surfactants such as ethoxylated fatty alcohols.

Processing aids, when present in the cleaning compositions, preferably comprise from about 0.02 wt % to about 10 wt %, more preferably from about 0.05 wt % to about 10 wt %, even more preferably from about 0.1 wt % to about 10 wt % by weight of the cleaning composition. Processing aids, when present in the consumable detergent compositions, preferably comprise from about 1 wt % to about 75 wt %, more preferably from about 5 wt % to about 50 wt % by weight of the consumable detergent composition.

Suitable odor control agents, which may optionally be used as finishing agents, include agents include, cyclodextrins, odor neutralizers, odor blockers and mixtures thereof. Suitable odor neutralizers include aldehydes, flavanoids, metallic salts, water-soluble polymers, zeolites, activated carbon and mixtures thereof.

Perfumes and perfumery ingredients useful in the detergent compositions for the present invention comprise a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes may comprise extremely complex mixtures of such ingredients. Pro-perfumes are also useful in the present invention. Such materials are those precursors or mixtures thereof capable of chemically reacting, e.g., by hydrolysis, to release a perfume, and are described in patents and/or published patent applications to Procter and Gamble, Firmenich, Givaudan and others.

Bleaches, especially oxygen bleaches, are another type of laundry additive suitable for use in the detergent compositions for the present invention. This is especially the case for the activated and catalyzed forms with such bleach activators as nonanoyloxybenzenesulfonate and/or any of its linear or branched higher or lower homologs, and/or tetraacetylethylenediamine and/or any of its derivatives or derivatives of phthaloylimidoperoxycaproic acid (PAP; available from Ausimont SpA under trademane Euroco) or other imido- or amido-substituted bleach activators including the lactam types, or more generally any mixture of hydrophilic and/or hydrophobic bleach activators (especially acyl derivatives including those of the C6-C16 substituted oxybenzenesulfonates).

Also suitable are organic or inorganic peracids both including PAP and other than PAP. Suitable organic or inorganic peracids for use herein include, but are not limited to: percarboxylic acids and salts; percarbonic acids and salts; perimidic acids and salts; peroxymonosulfuric acids and salts; persulphates such as monopersulfate; peroxyacids such as diperoxydodecandioic acid (DPDA); magnesium peroxyphthalic acid; perfauric acid; perbenzoic and alkylperbenzoic acids; and mixtures thereof.

Detersive enzymes such as proteases, amylases, cellulases, lipases and the like as well as bleach catalysts including the macrocyclic types having manganese or similar transition metals all useful in laundry and cleaning products can be used herein at very low, or less commonly, higher levels. Laundry Additives that are catalytic, for example enzymes, can be used in “forward” or “reverse” modes. For example, a lipolase or other hydrolase may be used, optionally in the presence of alcohols as laundry additives, to convert fatty acids to esters, thereby increasing their solubility in the lipohilic fluid.

Nonlimiting examples of finishing polymers that are commercially available are: polyvinylpyrrolidone/dimethylaminoethyl methacrylate copolymer, such as Copolymer 958®, weight average molecular weight of about 100,000 daltons and Copolymer 937, weight average molecular weight of about 1,000,000 daltons, available from GAF Chemicals Corporation; adipic acid/dimethylaminohydroxypropyl diethylenetriamine copolymer, such as CARTARETIN F-4® and F-23, available from Sandoz Chemicals Corporation; methacryloyl ethyl betaine/methacrylates copolymer, such as DIAFORMER Z-SM®, available from Mitsubishi Chemicals Corporation; polyvinyl alcohol copolymer resin, such as VINEX 2019®, available from Air Products and Chemicals or MOWEO1®, available from Clariant; adipic acid/epoxypropyl diethylenetriamine copolymer, such as DELSETTE 101®, available from Hercules Incorporated; polyamine resins, such as CYPRO 515®, available from Cytec Industries; polyquaternary amine resins, such as KYMENE 557H®, available from Hercules Incorporated; and polyvinylpyrrolidone/acrylic acid, such as SOKALAN EG 310®, available from BASF.

The cleaning additive may also be an antistatic agent. Any suitable well-known antistatic agents used in conventional laundering and dry cleaning are suitable for use in the detergent compositions and methods of the present invention. Especially suitable as antistatic agents are the subset of fabric softeners which are known to provide antistatic benefits. For example those fabric softeners that have a fatty acyl group which has an iodine value of above 20, such as N,N-di(tallowoyl-oxy-ethyl)-N,N-dimethyl ammonium methylsulfate. However, it is to be understood that the term antistatic agent is not to be limited to just this subset of fabric softeners and includes all antistatic agents.

Preferred insect and moth repellent laundry additives useful in the compositions of the present invention are perfume ingredients, such as citronellol, citronellal, citral, linalool, cedar extract, geranium oil, sandalwood oil, 2-(diethylphenoxy)ethanol, 1-dodecene, etc. Other examples of insect and/or moth repellents useful in the compositions of the present invention are disclosed in U.S. Pat. Nos. 4,449,987; 4,693,890; 4,696,676; 4,933,371; 5,030,660; 5,196,200; and in “Semio Activity of Flavor and Fragrance Molecules on Various Insect Species”, B. D. Mookherjee et al., published in Bioactive Volatile Compounds from Plants, ACS Symposium Series 525, R. Teranishi, R. G. Buttery, and H. Sugisawa, 1993, pp. 35-48.

### G. SERVICING A NON-AQUEOUS LAUNDERING APPARATUS

Another embodiment of the present invention includes the step of servicing a non-aqueous laundering apparatus. Over time, small amounts of lipophilic fluid and/or adjuncts may be lost from the non-aqueous laundering apparatus through retention on the fabric articles cleaned in the non-aqueous laundering apparatus; filters get filled; and mechanical parts may become worn. Additionally, the user may prefer the convenience of not having to ever add any adjunct fluids to the non-aqueous laundering apparatus. Consequently, the servicing step may include addressing one or more of these needs.

Servicing may be performed at the installation site, or may involve removal of the non-aqueous laundering apparatus from its installation site to a separate servicing site for servicing.

In one embodiment, servicing includes checking all mechanical, electrical and chemical components of the non-aqueous laundering apparatus, and replacing and/or upgrading any such components in need of replacement/upgrade.

In one embodiment, servicing includes replacing any lipophilic fluid that may have been lost during use prior to servicing. In another embodiment, servicing may include complete removal of the lipophilic fluid from the non-aqueous laundering apparatus and replacement with fresh lipophilic fluid. In another embodiment, the lipophilic fluid is removed and cleaned (e.g., impurities, such as sebum, it may have picked up during the non-aqueous laundering process are removed) at the servicing site the service technician, and the refreshed lipophilic fluid is returned to the non-aqueous laundering apparatus. Where the servicing site is also the installation site (e.g., in a user's home), the servicing technician may bring a portable cleaning system for such cleaning of the lipophilic fluid.

Servicing may also include the adding and/or replacement of impinging gases and or adjuncts into the non-aqueous laundering apparatus.

Servicing may further include replacing the non-aqueous laundering apparatus with the same component the user has been using or with an upgraded component. The components may be a storage tank, a filter, an applicator, a sensor, a recovery system, a user interface, a control system, or the system software.

Certain embodiments of the non-aqueous laundering apparatus may include the ability to clean and reuse the lipophilic fluid for more than one automatic laundry process. A preferred means for cleaning the lipophilic fluid for multiple uses is a replaceable filter. Such filter typically includes filter materials capable of removing and collecting at least the body soils removed from the fabric articles during the automatic home laundry process. Activated charcoal, silicas, molecular sieves, and/or hydrophobically modified papers are just some optional components of such filters. The filter is removably attached to the non-aqueous laundering apparatus by means that the consumer can readily remove and replace the filter at regular intervals. However, servicing could also include cleaning and/or replacement of such filters by a service technician.

### H. SERVICING VIA A NODE

Upon detection of a need for maintenance, supply level of non-aqueous laundering materials in comparison to a minimum supply level, etc., data can be transmitted to the node. The data is then processed to determine the necessary action. In one embodiment, the non-aqueous laundering apparatus can request service from the node for maintenance, re-supplying non-aqueous laundering materials wherein the re-supply amount is sufficient to at least restore the laundering materials to at or above the minimum supply level, recycling non-aqueous laundering materials, maintenance, and the like. In another embodiment, the node and the non-aqueous laundering apparatus can conduct a two-way communication where the non-aqueous laundering apparatus can request service from the node for maintenance, re-supplying non-aqueous laundering materials, recycling non-aqueous laundering materials, maintenance, and the like and the node can send data back to the non-aqueous laundering apparatus to facilitate servicing these problems. In a preferred embodiment, the servicing can occur without user intervention.

The node can be used in such a manner that the information gathered from it can be used to facilitate service. For example, the non-aqueous laundering apparatus can communicate with the node and report a need. This need can be relayed by the node to appropriate servicing services whereby the servicing services can provide the necessary service for the non-aqueous laundering apparatus.

All documents cited in the Detailed Description are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for instructing a non-aqueous laundering device to perform an automatic home laundry process in comprising:
loading fabric articles into the non-aqueous laundering device;
entering data describing the fabric articles; and
initiating the laundering process.

2. The method of claim 1, wherein the user enters the data.

3. The method of claim 2, wherein the user enters the data through a user interface.

4. The method of claim 3, wherein the user interface is selected from the group consisting of buttons, dials, touch screen, remote control, computer screen/mouse, computer screen/keyboard, and any combination thereof.

5. The method of claim 1, wherein the data further includes instructions to the laundering device to add additives and/or adjunct materials to the laundering process.

6. The method of claim 5, wherein the additives and/or adjunct material is a detergent composition, a surfactant, a perfume, an enzyme, or a bleach.

7. The method of claim 1, wherein the data further includes instructions to the laundering device to utilize a non-aqueous wash cycle, an aqueous wash cycle, or combinations thereof.

8. A method of performing an automatic home laundry process in a non-aqueous laundering device comprising:
receiving fabric articles into the laundering device;
receiving data describing the fabric articles;
processing the data to determine the laundering process; and
treating the fabric articles by the laundering process.

9. The method of claim 8, wherein the non-aqueous laundering device receives the data from the fabric articles or a user or a sensor.

10. The method of claim 8, wherein the non-aqueous laundering device receives the data from an identification tag attached to the fabric articles.

11. The method of claim 8, wherein the data comprises fabric type, type of stains, level of soiling, level of odor, color composition, color fastness, load size, or combinations thereof.

12. The method of claim 8, wherein the data further contains instructions to utilize a non-aqueous wash cycle, an aqueous wash cycle, or combinations thereof.

13. The method of claim 12, wherein the laundering device selects the appropriate detergent composition and/or additives for the aqueous or non-aqueous wash cycle.

14. The method of claim 8, wherein the non-aqueous laundering device receives the data from a user through a user interface.

15. The method of claim 14, wherein the user interface is selected from the group consisting of buttons, dials, touch screen, remote control, computer screen/mouse, computer screen/keyboard, and any combination thereof.

16. The method of claim 14, wherein the data includes instructions to the laundering device to add lipophilic fluids, detergent compositions, additives and/or adjunct materials to the laundering process.

17. The method of claim 14, wherein the data f includes instructions to the laundering device to utilize a non-aqueous wash cycle, an aqueous wash cycle, or combinations thereof.

18. A method of servicing a non-aqueous laundering device comprising:
gathering data by the non-aqueous laundering device;
delivering data to a node;
receiving return data from the node; and
receiving service within the non-aqueous laundering device.

19. The method of claim 18, wherein the delivering of the data occurs when the laundering materials or the system components need servicing.

20. The method of claim 18, wherein the delivering of the data or the receiving of the data occurs using an internet, an intranet, a networking system, a telephone including voice lines and data lines, cellular technology, satellite technology, cable technology, radio waves, optical transmissions, and combinations thereof.

21. The method of claim 18, wherein the node is a machine or a human.

22. The method of claim 18, wherein the service comprises:
(a) replacing or replenishing laundering materials;
(b) performing repair or maintenance of components;
(c) replacing or upgrading components; and
d) combinations thereof.

23. The method of claim 22 wherein the laundering material is selected from the group consisting of lipophilic fluids, polar solvents, detergent compositions, surfactants, adjuncts, and mixtures thereof; and the component is selected from the group consisting of a storage tank, a filter, an applicator, a sensor, a recovery system, a user interface, a control system, a system software,.and combinations thereof.

24. A method of re-supplying a non-aqueous laundering device comprising,
determining a supply level of a non-aqueous laundering material within the laundering device;
comparing the supply level of the non-aqueous laundering material with a minimum supply level of the non-aqueous laundering material;
transmitting a supply request to a node when the supply level is less than the minimum supply level; and
receiving a re-supply amount of the non-aqueous laundering material within the laundering device;
wherein the re-supply amount is at least equal to the difference between the supply level and the minimum supply level.

25. The method of claim 24, wherein the non-aqueous laundering material is a solvent, a detergent, an additive or an adjunct.

26. The method of claim 24, wherein the transmitting occurs using an internet, an intranet, a networking system, a telephone including voice lines and data lines, cellular technology, satellite technology, cable technology, radio waves, optical transmissions, and combinations thereof.

27. The method of claim 24, wherein the node is a machine or a human.

28. The method of claim 24, wherein the re-supply amount of the non-aqueous laundering materials is received without user intervention.
